(19) United States
(12) Patent Application Publication
(10) Pub. No.: US 2008/0223403 A1
(43) Pub. Date: Sep. 18, 2008

(54) System for Handling Gases when Treating the Interior of a Vehicle

(76) Inventor: Jerad Allen Ford, Columbus, OH (US)

Correspondence Address: BATTELLE MEMORIAL INSTITUTE, 505 KING AVENUE, COLUMBUS, OH, 43201-2693, US

(21) Appl. No.: 12/088,912

(22) PCT Filed: Oct. 4, 2006
(86) PCT No.: PCT/US06/38797

§ 371 Date: Apr. 1, 2008

Related U.S. Application Data
(60) Provisional application No. 60/723,402, filed on Oct. 4, 2005.

(51) Int. Cl. B01D 46/42; B08B 15/00; B64F 1/36

(52) U.S. Cl. 134/8; 55/356; 134/22.18; 134/21

(57) ABSTRACT

A portable system (8) for handling gases when treating a surface within an interior space of an object. The object has one or more openings (20a, 22) that can be used as an inlet opening (26) and one or more openings that can be used as an outlet opening (28). The portable system includes a seal assembly (30) configured to substantially seal the outlet opening and an evacuation unit connected to the seal assembly. The seal assembly has the capability of being moved to the object. The evacuation unit (44) is configured to establish a flow of gases within the interior space of the object. The evacuation unit has the capability of being moved to the object. The flow of gases within the interior space of the object substantially removes particulates and/or volatiles from the interior space. The portable system also includes a filtering unit (50) which is configured to treat the gases. The filtering unit has the capability of being moved to the object.

### RELATED APPLICATIONS

This application relates to and claims the benefit of U.S. Provisional Patent Application No. 60/723,402 filed on Oct. 4, 2005.

### TECHNICAL FIELD

This invention relates to a system for handling gases when treating surfaces of an object or vehicle. More particularly this invention relates to a system for handling gases when treating surfaces within the interior spaces of an object or vehicle, such as the interior of airplanes.

### BACKGROUND OF THE INVENTION

Treating surfaces, such as for example painting or sandblasting, within large interior spaces of vehicles, such as the interiors of airplanes, ships, trains, buses, RVs, and military vehicles, can be an involved, time-consuming and inefficient process. For example, painting within the interior spaces of an airplane typically involves interrupting any ongoing maintenance work and transporting the airplane to a dedicated painting facility equipped to paint the interior of the plane in an efficient and environmentally acceptable manner.

It is common for maintenance personnel to be required to enter the interior spaces within the vehicles to complete necessary maintenance and surface treatment tasks. The maintenance personnel must be protected from potentially hazardous particulates, volatile organic compounds and/or volatiles, and care must be taken to avoid applying chemicals, cleaning agents and/or paint to areas outside the desired work areas. When aircraft cannot be moved to an environmentally controlled facility, restrictions are commonly employed to avoid exposure of workers to potentially hazardous particulates, volatile organic compounds and/or volatiles. The restrictions employed typically decrease the productivity of the maintenance process. As an example, painting operations for airplanes typically are restricted to occur only during third shift, and hangar doors are required to be open and staff to be evacuated to minimize exposure to paint components. In another example, treating surfaces within the interior of an aircraft is limited to minimal amounts of work extended over long periods of time. The extension of the work reduces any exposure to maintenance personnel to potentially hazardous particulates, volatile organic compounds and/or volatiles. However, the extension of work is inefficient and costly. The requirement to move the aircraft from a maintenance facility to a dedicated paint facility precludes simultaneous painting and maintenance, thereby increasing the time the aircraft is out of service.

It would be advantageous if there could be developed improved systems and methods for handling gases when treating surfaces within the interior spaces of a vehicle.

### SUMMARY OF THE INVENTION

The above objects as well as other objects not specifically enumerated are achieved by a portable system for handling gases when treating a surface within an interior space of an object. The object has one or more openings that can be used as an inlet opening and one or more openings that can be used as an outlet opening. The portable system includes a seal assembly configured to substantially seal the outlet opening and an evacuation unit connected to the seal assembly. The seal assembly has the capability of being moved to the object. The evacuation unit is configured to establish a flow of gases within the interior space of the object. The evacuation unit has the capability of being moved to the object. The flow of gases within the interior space of the object substantially removes particulates and/or volatiles from the interior space. The portable system also includes a filtering unit which is configured to treat the gases. The filtering unit has the capability of being moved to the object.

According to this invention there is also provided a method of handling gases when treating a surface within the interior spaces of a vehicle. The method includes the steps of providing a vehicle, where the vehicle has a plurality of interior spaces. The vehicle also has a plurality of openings which extend from the interior of the vehicle to an exterior of the vehicle. One or more openings are selected to be inlet openings. The inlet openings are configured to allow a flow of gases into the interior space of the vehicle. One or more openings are selected to be outlet openings. The outlet openings are configured to allow the flow of gases to exit the interior space. A portable sealing assembly seals the outlet openings. The remaining vehicle openings are sealed. A flow of gases is established. The flow extends through the interior space of the vehicle from the inlet openings to the outlet openings. The flow of gases within the interior space substantially removes one or more of the 1) particulates and 2) volatiles from the interior space. The interior surfaces of the vehicle within the interior space are treated. The gases exiting the interior space are treated with a filtering unit. The filtering unit has the capability of being moved to the vehicle.

According to the invention there is also a method of handling gases when treating a surface within the interior spaces of a vehicle. The method includes the steps of transporting a vehicle to an operational area, where the vehicle has a plurality of interior spaces. The vehicle also has a plurality of openings which extend from the interior of the vehicle to an exterior of the vehicle. One or more openings are selected to be inlet openings. The inlet openings are configured to allow a flow of gases into the interior space of the vehicle. One or more openings are selected to be outlet openings. The outlet openings are configured to allow the flow of gases to exit the interior space. A portable sealing assembly seals the outlet openings. The remaining vehicle openings are sealed. A flow of gases is established. The flow extends through the interior space of the vehicle from the inlet openings to the outlet openings. The flow of gases within the interior space substantially removes one or more of the 1) particulates and 2) volatiles from the interior space. The interior surfaces of the vehicle within the interior space are treated. The gases exiting the interior space are treated with a filtering unit. The filtering unit has the capability of being moved to the vehicle.

### BRIEF DESCRIPTION OF THE DRAWINGS

FIG. 1 is a side view in elevation of an aircraft.

FIG. 2 is a perspective view of the aircraft of FIG. 1 configured with a portable system for treating a surface within the interior space of an aircraft.

FIG. 3 is a front view in elevation of an aircraft fuselage having an opening sealed with the portable system of FIG. 2.

FIG. 4 is a side view in elevation of the aircraft fuselage having an opening sealed with the portable system of FIG. 2.

FIG. 5 is a front view in elevation of an opening seal of the portable system of FIG. 2.

FIG. 6 is a side view of an alternate embodiment of the portable system of FIG. 2 illustrating an aircraft fuselage having a window.

FIG. 7 is a side view of the alternate embodiment of the portable system of FIG. 6 illustrating an opening housing.

### DESCRIPTION OF THE INVENTION

The description and drawings disclose a system for handling gases when treating surfaces within the interior spaces of an object or a vehicle. A vehicle is defined as a device or structure for transporting persons or things. Various examples of vehicles include aircraft, ships, buses, train cars, recreational vehicles, military vehicles or any other device or structure sufficient to transport persons or things.

Vehicles, such as aircraft, buses, and trains, typically have interior surfaces, such as seats, counters, walls, partitions, ceilings, and the like. The interior surfaces are located within the interior spaces of the vehicle. Specialized vehicles, such as aircraft and ships, can have interior spaces that include cargo holds, tanks, pump rooms, cofferdams, passenger compartments, cockpits, cargo bays, weapons bays, and luggage compartments.

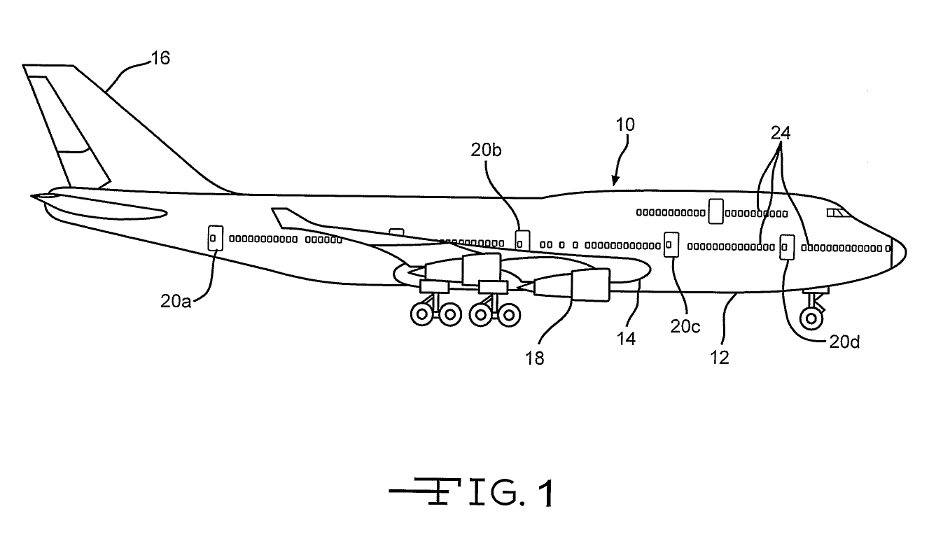

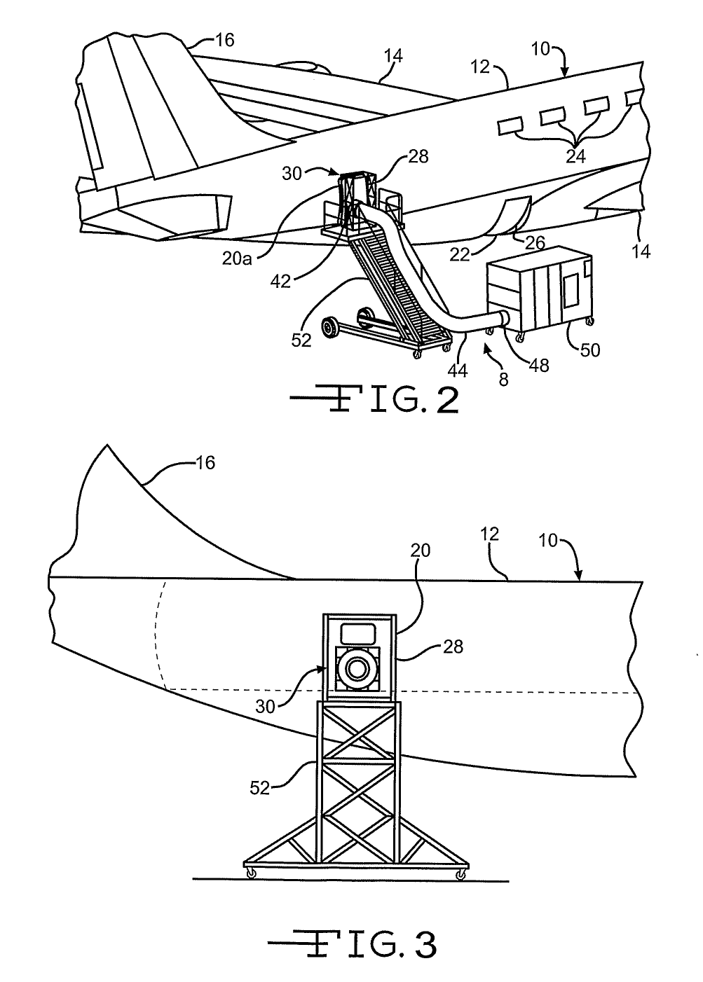

A typical aircraft 10 is shown in FIGS. 1 and 2. The aircraft 10 includes a fuselage 12 configured to contain the passengers, crew, luggage and cargo. The aircraft 10 also includes a pair of opposed wings 14, a tail 16 and a plurality of engines 18. The fuselage 12 contains a plurality of openings configured for various purposes. The openings can include passenger entry and egress doorways 20a, 20b, 20c, and 20d, cargo bay doors 22, weapons bay doors (not shown), and windows 24.

As previously mentioned, the fuselage 12 includes a plurality of interior spaces, such as for example passenger compartments, the cockpit, cargo bays, weapons bays, and luggage compartments. In order to allow maintenance personnel to effectively and safely treat surfaces and perform required work tasks within the interior spaces of the fuselage 12, a portable gas handling system 8 is provided. Portable is defined to mean the gas handling system 8 can be operated in one location and subsequently transported and operated in another location. In this embodiment, the gas handling system 8 can be transported and operated in any location in which the object or vehicle exists. In general, the gas handling system 8 directs a controlled flow of gases within the interior space of a vehicle. The flow of gases can substantially evacuate particulates, volatile organic compounds (VOCs) and/or volatiles from the interior space. Once evacuated from the interior space, the evacuated particulates, volatile organic compounds and/or volatiles are filtered from the airflow. The gas handling system 8 is portable resulting in the elimination of dedicated surface treatment facilities having permanent equipment, such as, for example a hangar dedicated to painting airplanes. Furthermore, the gas handling system 8 allows for other maintenance tasks, such as engine maintenance, to be performed simultaneously with the surface treatment, thereby saving time and labor.

Treating an interior surface is defined as subjecting the interior surface to a process, action, or change, such as a chemical or physical process or application. As examples, treating an interior surface can include priming, painting, cleaning, sandblasting, stripping, lubricating, fumigating, etching or any other process or action that subjects the interior surface to a chemical or physical process.

In one embodiment as best shown in FIG. 2, the gas handling system 8 includes configuring a passenger doorway 20a, 20b, 20c or 20d, a cargo bay door 22, a weapons bay door, or a port into an inlet opening 26. The inlet opening 26 is configured to allow a flow of gases to enter the interior space of the aircraft 10. In another embodiment, the gas handling system 8 can include any number of inlet openings 26.

The flow of gases is configured to substantially capture and transport airborne particulates, volatile organic compounds and/or volatiles contained in the interior space. In this embodiment, the gas is air. In another embodiment, the gas can be any fluid sufficient to substantially capture and transport airborne particulates, volatile organic compounds and/or volatiles contained in the interior space. In yet another embodiment, the gases can be configured to substantially absorb particulates, volatile organic compounds and/or volatiles contained in the interior space.

In this embodiment, the system 8 also includes an outlet opening 28 as shown in FIG. 2. The outlet opening 28 is configured to allow the exit of the gases flowing into the interior space from the inlet opening 26. Similar to the inlet opening 26, the outlet opening 28 can be any passenger doorway 20, cargo bay door 22, port, or weapons bay door, configured to allow the exit of the gases flowing into the interior space from the inlet opening 26. In another embodiment, the gas handling system 8 can include any number of outlet openings 28.

As best shown in FIGS. 4, 6 and 7, the gas handling system 8 includes a portable seal assembly 30. The seal assembly 30 includes an opening cover 32 configured to substantially cover the outlet opening 28. As best shown in FIG. 4, the opening cover 32 includes a fuselage seal 34. The fuselage seal 34 is configured to substantially seal the opening cover 32 against the fuselage 12 and provide a substantially air-tight connection between the fuselage 12 and the opening cover 32. In this embodiment, the fuselage seal 34 is substantially conformable to the exterior shape of the fuselage 12. In another embodiment, the fuselage seal 34 can be another shape, sufficient to substantially seal the opening cover 32 against the fuselage 12 and provide a substantially air-tight connection between the fuselage 12 and the opening cover 32. In this embodiment, the fuselage seal 32 is a short-haired brush configured to contact the fuselage 12. In another embodiment, the fuselage seal 34 can be a lip (not shown) extending around the perimeter of the opening cover 32. The lip can be made of any material, such as a resilient rubber or polymeric material, or any other material sufficient to substantially seal against the fuselage 12. Alternatively, the fuselage seal 34 could be another structure or assembly, such as a plurality of magnetic connectors or and inflatable bladder that cooperates with the outlet opening 26 to substantially seal the opening cover 32 against the fuselage 12.

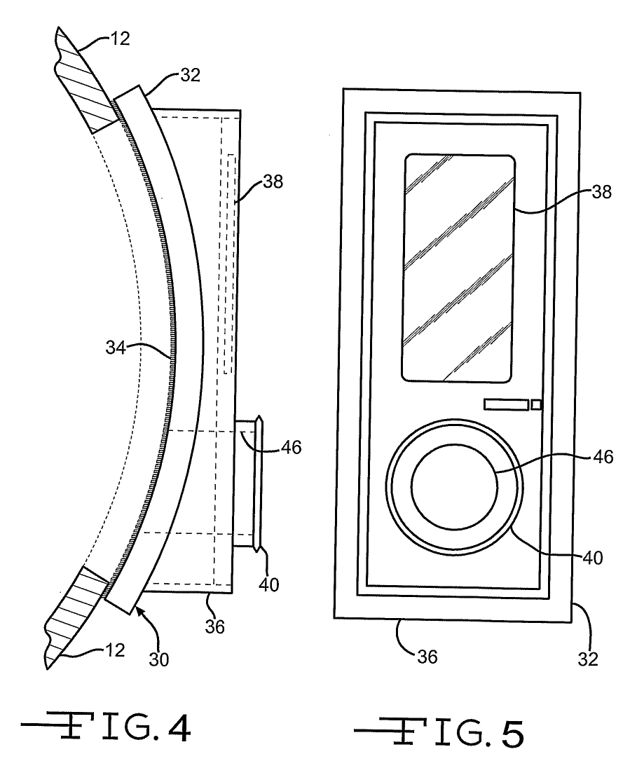

As shown in FIGS. 4 and 5, the seal assembly 30 further includes a housing 36 attached to the exterior of the opening cover 32. The purpose of the housing is to provide an optional housing window 38 and an adapter 40. The optional window 38 is configured to allow maintenance personnel to view into the interior of the fuselage 12 during the surface treatment process. However, the optional window 38 is not necessary to the operation of the gas handling system 8.

The seal assembly 30 also includes an adapter 40 as best shown in FIGS. 4 and 5. The adapter 40 defines an outlet aperture 46 and is configured to connect to a first end 42 of an evacuation hose 44. In this embodiment, the adapter 40 is a circular member. In another embodiment, the adapter 40 can have another cross-sectional shape, such as square or rectangular, sufficient to define the outlet aperture 46 and connect to the first end 42 of the evacuation hose 44.

As previously mentioned and as best shown in FIG. 2, the adapter 40 is connected to a first end 42 of an evacuation hose 44. The evacuation hose 44 is arranged such that a second end 48 of the evacuation hose 44 connects to a filtration unit 50. In this embodiment, the evacuation hose 44 is made of flexible plastic and has an 18 inch diameter. In another embodiment, the evacuation hose 44 can be made of another material, such as a reinforced polymeric material, or any other material sufficient to connect to the filtration unit 50. In this embodiment, the diameter of the evacuation hose 44 is sized to effectively handle the flow of the gases from the outlet opening 28. In another embodiment, the evacuation hose 44 can be any diameter in size, such as from 8 inches to 24 inches, or any other diameter in size sufficient to effectively handle the flow of gases from the outlet opening 28.

In this embodiment as best shown in FIG. 2, the second end 48 of the evacuation hose 44 connects to a filtration unit 50. In another embodiment, the filtration unit 50 can be configured to connect to the adapter 40 and eliminate the need for the evacuation hose 44.

The filtration unit 50 is portable and configured to create the flow of gases. In this embodiment, the filtration unit 50 creates the flow of gases by creating a partial vacuum within the evacuation hose 44. The partial vacuum within the evacuation hose 44 creates a partial vacuum within the interior space. The partial vacuum within the interior space draws a flow of gases into the inlet opening 26. In another embodiment, the flow of gases into the inlet opening 26 and through the interior space can be created by another assembly or structure, including by a blower. The blower can blow gases into the inlet opening 26 sufficient to create the flow of gases into the inlet opening 26 and through the interior space. In such an arrangement, the gauge pressure within the interior spaces of the aircraft 10 would be positive rather than negative.

The flow of gases created by the evacuation unit 44 can vary according to the cross-sectional area of the interior space being treated. Typical air flows can range from about 100 CFM for an extremely small cross-sectional area to as high as 40,000 CFM for a large cross-sectional area.

The filtration unit 50 is further configured to filter the flow of gases and thereby substantially remove particulates, volatile organic compounds and/or volatiles. In this embodiment, the filtration unit 50 meets the filtration efficiency requirements of NESHAP (National Emission Standards for Hazardous Air Pollutants) for Aerospace Manufacturing and Rework Facilities using Test Method 319. Test Method 319 specifies filtration efficiency of an overspray arrester. Test Method 319 tests filtration efficiency for particulates ranging in diameter from 0.3 to 10 μm. Test Method 319 tests with both liquid-phase and solid-phase particles and the tests are conducted at a face velocity of 120 fpm. In this embodiment, the filtration unit 50 includes a three stage filtration system (not shown) and carbon absorption cells (not shown). One example of a three stage filtration system is the Aerospace Paint Overspray Collection System from the Global Finishing Systems Corporation in Osseo, Wis. Carbon adsorption cells are commercially available, such as for example, the carbon adsorption cells from Global Finishing Systems Corporation in Osseo, Wis. However, other three stage filtration systems and other carbon adsorption cells, sufficient to substantially remove particulates, volatile organic compounds and/or volatiles, can be used.

In this embodiment, the filtration unit 50 is configured to filter the flow of gases and thereby substantially remove particulates, volatile organic compounds and/or volatiles. After filtering by the filtration unit 50, the flow of gases is released to the ambient air. In another embodiment, the flow of gases can be further treated or captured, such as for example, a container for transport. In this embodiment, the flow of gases is sufficiently filtered such that upon release into the ambient air, the flow of gases has no adverse effect on personnel.

In this embodiment, the filtration unit 50 is configured to simultaneously create the flow of gases in the interior space of the aircraft 10 and filter the flow of gases and thereby substantially remove particulates, volatile organic compounds and/or volatiles. In another embodiment, the filtration unit 50 could be configured to filter the flow of gases and another, separate device, such as a vacuum pump, could be configured to create the flow of gases. In yet another embodiment, the filtration unit 50 could be configured to create the flow of gases and another, separate device, such as purifier, could be configured to filter the flow of gases and thereby substantially remove particulates, volatile organic compounds and/or volatiles.

As best shown in FIGS. 2 and 3, the opening seal assembly 30 is supported by a work platform 52. The work platform 52 is configured to position the opening seal assembly 30 against the fuselage 12 such that the opening seal assembly 30 substantially encloses the outlet opening 28. As shown in FIGS. 2 and 3, the work platform 52 can be configured in different structures, including a staired work platform 52 as shown in FIG. 2, or a trussed work platform as shown in FIG. 3. Alternatively, the work platform 52 can be any structure, such as a scissor-lift platform or a hydraulic lift platform, sufficient to position the opening seal assembly 30 against the fuselage 12 such that the opening seal assembly 30 substantially encloses the outlet opening 28.

As further shown in FIGS. 2 and 3, the work platform 52 includes optional casters 54. The casters 54 allow workers to readily move the work platform 52 from one location to another location. However, the casters 44 are not necessary to the operation of the gas handling system 8.

In operation, the gas handling system 8 can be transported to any location, such as an airport, harbor, dock, train station, or any other location in which a vehicle having interior spaces is located. Alternatively, a vehicle can be transported to an operational area. An operational area is defined as any location having the gas handling system 8 and where surface treatment is to be done, Examples of operational areas include a hangar equipped with a paint booth containing the gas handling system 8 and an assembly line within a manufacturing facility containing the gas handling system 8. However, operational areas can include other locations and facilities containing the gas handling system 8 and sufficient for the surface treatment to be done. An operational area does not include dedicated facilities having permanent equipment for treating surfaces of objects.

Once the surface needing treatment and the interior space is determined, one or more openings are selected to be an inlet opening 26. In this embodiment as shown in FIG. 2, the inlet opening 26 can be a single opening such as a cargo door. In another embodiment, more than one opening can be selected and configured to be the inlet opening 26. The inlet opening 26 is configured to allow the flow of gases into the interior space. One or more openings are selected to be an outlet opening 28. In this embodiment as shown in FIG. 2, the outlet opening 28 can be a single opening such as a passenger door 20a. In another embodiment, more than one opening can be selected and configured to be the outlet opening 28. The outlet opening 28 is substantially sealed by the seal assembly 30. The outlet opening 28 is configured to allow the flow of gases to exit the interior space. The remaining openings, such as doorways and windows, are substantially sealed. A flow of gases is established within the interior space. In this embodiment, the flow of gases is established by a partial vacuum created by the filtration unit 50. The flow of gases enables a steady introduction of the gases into the interior space to substantially capture and transport potentially hazardous particulates, volatile organic compounds and/or volatiles. Maintenance personnel enter the interior space and treat the surface. It should be appreciated that the interior spaces within an object or vehicle can be uniquely shaped. The flow of gases within the uniquely shaped interior space can be controlled in various manners, such as by blocking compartments and passages within the interior space with barriers, blocking various openings 20 within the vehicle, diverting or mixing the flow of gases with fans or fresh air influents, and by varying the flow as created by the filtration unit 50. The flow of gases substantially evacuates particulates, volatile organic compounds and/or volatiles from within the interior space. The evacuated particulates, volatile organic compounds and/or volatiles within the flow of gases are directed out of the interior space through the aperture 46 in the seal assembly 30. The flow of gases passes through the evacuation hose 44 and into the filtration unit 50 for processing.

In this embodiment as shown in FIG. 2, the path of the flow of gases is to enter the aircraft at the cargo bay doors selected as the inlet opening 26. The flow of gases extend through the interior space of the aircraft 10 and exit at the passenger door 20a selected as the outlet opening 28. The path of the flow of gases can be different using different inlet openings 26 and outlet openings 28. In another embodiment, for example, the path of the flow of gases can enter the aircraft at a passenger door 20a, as shown in FIG. 1, and exit the aircraft at passenger door 20b. Alternatively, the path of the flow of gases can enter the aircraft 10 at a passenger door 20a, as shown in FIG. 1, and extend the length of the aircraft 10 so as to exit the aircraft 10 at passenger door 20d.

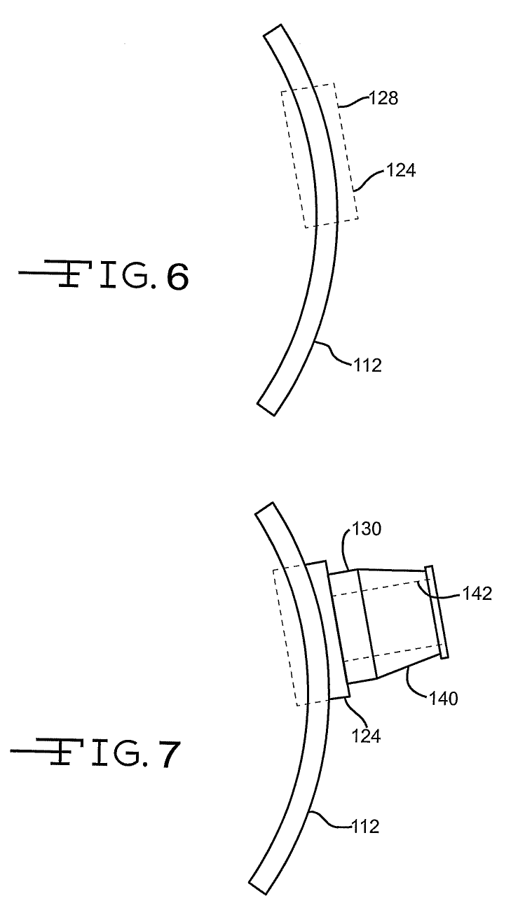

In another embodiment as shown in FIGS. 6 and 7, the outlet opening 128 is a window 124 disposed in the fuselage 112. As shown in FIG. 7, the system 108 includes a seal assembly 130. The seal assembly 130 can be configured to seal against the window 124 in the same manner in which the seal assembly 30 seals against the outlet opening 28. The seal assembly 130 is configured to substantially seal against the window 124 and provide a substantially air-tight connection between the window 124 and the seal assembly 130. The seal assembly 130 also includes an optional adapter 140 as shown in FIG. 7. The adapter 140 defines an outlet aperture 146 and is configured to connect to a first end of an evacuation hose (not shown). In this embodiment, the adapter 140 is a circular member. In another embodiment, the adapter 140 can be another cross-sectional shape, such as a square or rectangular shape, sufficient to define the outlet aperture 146 and connect to the evacuation hose.

The principle and mode of operation of this invention have been described in its preferred embodiments. However, it should be noted that this invention may be practiced otherwise than as specifically illustrated and described without departing from its scope.

What is claimed is:

1. A portable system for handling gases when treating a surface within an interior space of an object, the object having one or more openings that can be used as an inlet opening, the object having one or more openings that can be used as an outlet opening, the portable system comprising:
a seal assembly configured to substantially seal the outlet opening, the seal assembly having the capability of being moved to the object;
an evacuation unit connected to the seal, the evacuation unit being configured to establish a flow of gases within the interior space of the object, the evacuation unit having the capability of being transported to the object, wherein the flow of gases within the interior space of the object substantially removes one or more of the particulates and volatiles from the interior space; and
a filtering unit configured to treat the gases, the filtering unit having the capability of being moved to the object.

2. The portable system of claim 1 in which the object is a vehicle.

3. The portable system of claim 1 in which the evacuation unit establishes the flow of gases by a partial vacuum.

4. The portable system of claim 1 in which the filtering unit meets the specifications for NESHAP Method 319.

5. The portable system of claim 1 in which the filtering unit removes volatile organic compounds (VOCs) from the gases.

6. The portable system of claim 1 in which one end of an evacuation hose is connected to the outlet opening and the other end of the evacuation hose is connected to the evacuation unit.

7. The portable system of claim 1 in which the filtering unit substantially removes particulates and volatiles from the gases.

8. The portable system of claim 7 in which the gases are released into the ambient air, wherein the released gases have no adverse effect on personnel.

9. A method of handling gases when treating a surface within the interior spaces of a vehicle, the method comprising:
providing a vehicle, the vehicle having a plurality of interior spaces, the vehicle having a plurality of openings extending from the interior of the vehicle to an exterior of the vehicle;
selecting one or more openings to be inlet openings, the inlet openings being configured to allow a flow of gases into the interior space of the vehicle;
selecting one or more openings to be outlet openings, the outlet openings being configured to allow the flow of gases to exit the interior space, sealing the outlet openings with a portable sealing assembly;
sealing the remaining vehicle openings;
establishing a flow of gases, the flow extending through the interior space of the vehicle from the inlet openings to the outlet openings, wherein the flow of gases within the interior space substantially removes one or more of the 1) particulates and 2) volatiles from the interior space;
treating the interior surface of the vehicle within the interior space; and
treating the gases exiting the interior space, wherein the gases are treated with a filtering unit, the filtering unit having the capability of being moved to the vehicle.

10. The method of claim 9 in which the flow of gases through the interior space is diverted by one or more of the group consisting of a fan, a fresh air influent, a blockade, and a barrier.

11. The method of claim 9 in which additional maintenance tasks are performed at the same time as the surface treatment.

12. The method of claim 9 in which the vehicle is one of the group consisting of an airplane, a ship, a military vehicle, a bus, a train, and a recreational vehicle.

13. The method of claim 9 in which the surface treatment is one of the group consisting of priming, painting, cleaning, sanding, sandblasting, stripping, fumigating, etching, paint removing.

14. The method of claim 9 in which the vehicle openings include doors, windows, bays, ports, and hatches.

15. The method of claim 9 in which the flow of gases is established by a partial vacuum.

16. The method of claim 9 in which the filtering of the gases exiting the interior space meets the specifications for NESHAP Method 319.

17. A method of handling gases when treating a surface within the interior spaces of a vehicle, the method comprising:
transporting the vehicle to an operational area, the vehicle having a plurality of interior spaces, the vehicle having a plurality of openings extending from the interior of the vehicle to the exterior of the vehicle;
selecting one or more openings to be inlet openings, the inlet openings being configured to allow a flow of gases into the interior space of the vehicle;
selecting one or more openings to be outlet openings, the outlet openings being configured to allow the flow of gases to exit the interior space, sealing the outlet opening with a portable sealing assembly;
sealing the remaining vehicle openings;
establishing a flow of gases, the flow extending through the interior space of the vehicle from the inlet openings to the outlet openings, wherein the flow of gases within the interior space substantially removes one or more of the 1) particulates and 2) volatiles from the interior space;
treating the interior surface of the vehicle within the interior space; and
treating the gases exiting the interior space, wherein the gases are treated with a filtering unit, the filtering unit having the capability of being moved to the vehicle.

18. The portable system of claim 17 in which the gases are released into the ambient air, wherein the released gases have no adverse effect on personnel.

19. The portable system of claim 17 in which the filtering unit removes volatile organic compounds (VOCs) from the gases.

20. The method of claim 17 in which additional maintenance tasks are performed at the same time as the surface treatment.

21. The method of claim 17 in which the vehicle is one of the group consisting of an airplane, a ship, a military vehicle, a bus, a train, and a recreational vehicle.

22. The method of claim 17 in which the surface treatment is one of the group consisting of priming, painting, cleaning, sanding, sandblasting, stripping, fumigating, etching, paint removing.

23. The method of claim 17 in which the vehicle openings include doors, windows, bays, ports, and hatches.

24. The method of claim 17 in which the flow of gases is established by a partial vacuum.

25. The method of claim 17 in which the filtering of the gases exiting the interior space meets the specifications for NESHAP Method 319.
